(19) United States
(12) Patent Application Publication
(10) Pub. No.: US 2016/0062481 A1
(43) Pub. Date: Mar. 3, 2016

(54) ELECTRONIC EQUIPMENT DISPLAYING VARIOUS KINDS OF INFORMATION AVAILABLE BY WEARING ON BODY

(71) Applicant: KYOCERA DOCUMENT SOLUTIONS INC., Osaka (JP)

(72) Inventors: Masato TANBA, Osaka (JP); Akira YUKI, Osaka (JP); Wataru ENDO, Osaka (JP); Ayaka IKEJIMA, Osaka (JP)

(73) Assignee: KYOCERA DOCUMENT SOLUTIONS INC., Osaka (JP)

(21) Appl. No.: 14/839,966

(22) Filed: Aug. 29, 2015

(30) Foreign Application Priority Data
Aug. 29, 2014 (JP) 2014-175560

(51) Int. Cl. G06F 3/03; G02B 27/01; G06K 9/46; G09G 5/00; G06F 3/01

(52) U.S. Cl. CPC G06F 3/0304; G09G 5/003; G06F 3/017; G06K 9/46; G02B 27/0172; G02B 2027/0178

(57) ABSTRACT

Provided is an electronic equipment that displays information in response to a variety of display requests of a user. The electronic equipment of the present disclosure is worn on the body. A communication circuit acquires various kinds of information from a various-information database in which the various kinds of information are stored via a network. A display circuit displays the various kinds of information. An imaging circuit images a real space. An object recognition circuit recognizes an object from an image imaged by the imaging circuit. A display request determination circuit determines a display request based on a combination of recognized different objects. Further, the display request determination circuit makes a transmission request for information to the various-information database in response to the display request through the communication circuit.

### INCORPORATION BY REFERENCE

This application is based on and claims the benefit of priority from Japanese Patent Application No. 2014-175560 filed on Aug. 29, 2014, the entire contents of which are hereby incorporated by reference.

### BACKGROUND

The present disclosure relates to an electronic equipment displaying various kinds of information available by wearing on the body.

Recently, it has been developed a wearable terminal such as a google (Registered Trademark) glass as an electronic equipment available by wearing on the body. This wearable terminal is designed to be able to always get access to the Internet or to a computer. Further, a user is able to walk while always displaying various kinds of information on the wearable terminal.

Incidentally, such a wearable terminal has a shortcoming that when the various kinds of information kept displaying thereon, the information comes inescapably into a user's view. For this reason, a user sometimes could feel troublesomeness. In such a case, it will become necessary to provide operation settings of displaying necessary information when needed.

In this connection, the google glass takes measures that a glass corresponding to a monitor is actuated by an operation of a touch pad attached to an ear hook part, and then necessary information is displayed on the glass by a voice operation. However, the voice operation is liable to cause an incorrect operation when a voice is drowned out by ambient noisy sounds. It is predicted for the voice operation that a user would take a long time to learn words required to operate the voice operation, and that a user unfamiliar to the voice operation would not become able to easily use the google glass.

A typical case of ensuring and facilitating such operation settings includes a technology of applying a display control method by gesture of a user to a display control device. This recognizes a user's motion of hand to be recognized by an instruction acquisition part, and acquires an instruction for operation. When it is detected by a detection part that an object is held by hand, a switching part switches a recognition object to the object. Due to this, it becomes possible to perform display control by gesture even when the gesture is input in a state where a user holds the object by hand.

### SUMMARY

An electronic equipment according to an embodiment of the present disclosure includes a communication circuit that acquires various kinds of information from a various-information database in which the various kinds of information are stored via a network; a display circuit that displays the various kinds of information; an imaging circuit that images a real space; an object recognition circuit that recognizes an object from an image imaged by the imaging circuit; and a display request determination circuit that determines a display request based on a combination of different objects recognized by the object recognition circuit, and makes a transmission request for information to the various-information database in response to the display request through the communication circuit.

An information display method according to an embodiment of the present disclosure is executed on a computer for control of an electronic equipment. The information display method includes the steps of acquiring various kinds of information from a various-information database in which various kinds of information are stored via a network through a communication circuit; displaying the various kinds of information by a display circuit; imaging a real space by an imaging circuit; recognizing an object by an object recognition circuit from an image imaged by the imaging circuit; and determining a display request by a display request determination circuit based on a combination of different objects recognized by the object recognition circuit and making a transmission request for information to the various-information database in response to the display request through the communication circuit.

A non-transitory computer readable storing medium according to an embodiment of the present disclosure stores an information display program executable on a computer of an electronic equipment. The information display program is causing the computer to function as: a communication circuit that acquires various kinds of information from a various-information database in which various kinds of information is stored via a network; a display circuit that display the various kinds of information; an imaging circuit that images a real space; an object recognition circuit that recognizes an object from an image imaged by the imaging circuit; and a display request determination circuit that determines a display request based on a combination of different objects recognized by the object recognition circuit, and makes a transmission request for information to the various-information database in response to the display request through the communication circuit.

### BRIEF DESCRIPTION OF THE DRAWINGS

FIG. 1 shows an embodiment in a case where an electronic equipment of the present disclosure is applied to an eyeglass-type wearable terminal;

FIG. 2 shows an internal configuration of the wearable terminal shown in FIG. 1;

FIG. 3 shows an example of a display request determination table referred by a display request determination part shown in FIG. 2; and

FIG. 4 shows steps of information display processing by the wearable terminal shown in FIG. 1.

### DETAILED DESCRIPTION

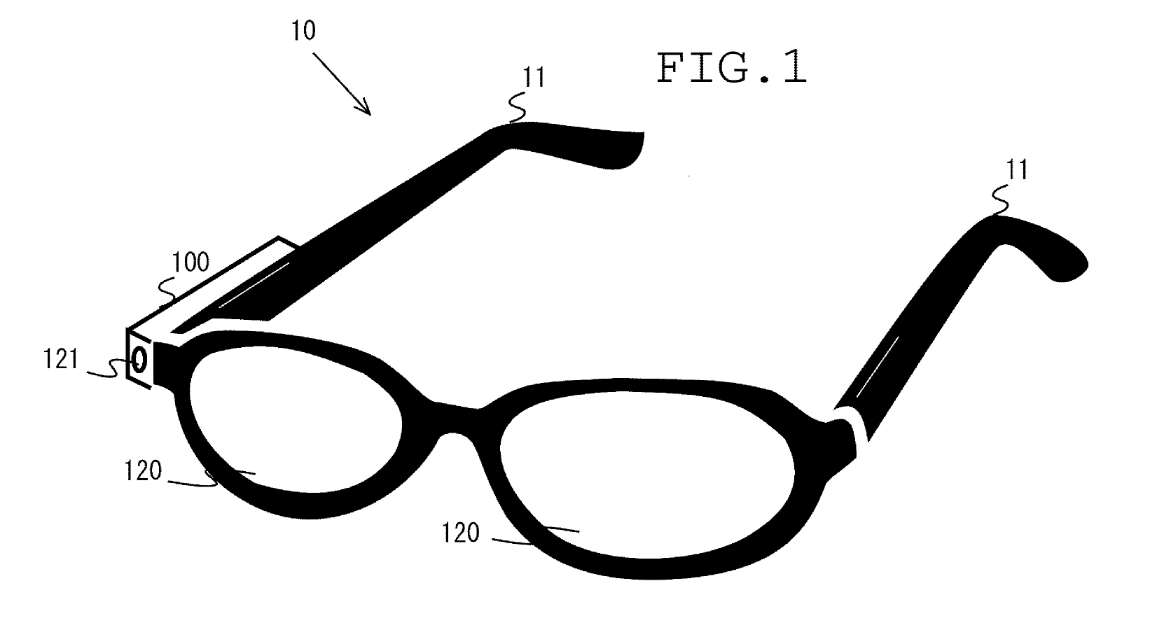

Hereinafter, an exemplary embodiment of an electronic equipment of the present disclosure will be described with reference to accompanying FIG. 1 to FIG. 3. An example of the electronic equipment in the following description is, for example, an eyeglass-type wearable terminal.

As shown in FIG. 1, a left and right wearable terminal 10 has a display part 120 and a temple part 11. The display part 120 displays various kinds of information. The temple part 11 uses for putting the wearable terminal 10 on ears. The display part 120 adopts, for example, an optical see-through. In other words, the display part 120 is configured to be able to transmit visible light. This allows a user who worn the wearable terminal 10 to directly see a scene of real space spreading before user's eyes transmitted through the display part 120. Additionally, the user can see various kinds of information displayed on the display part 120. Herein, the display part 120 may be made of a half mirror, for example.

At one temple part 11, there is arranged an equipment main body 100 having a camera 121 built therein. An imaging direction of an object by the camera 121 is coincided with a gaze direction of a user who worn the wearable terminal 10. This follows a motion of user's head who worn the wearable terminal 10 and images by the camera 121 an object in a gaze direction of a user. In this connection, the camera 121 uses, for example, an imaging element. Further, the camera 121 is, for example, a video camera capable of imaging an object in an imaging cycle of 1/30 seconds per one image. In other words, a frame rate is 30 fps. Thereby, the camera 121 can consecutively image the object in the gaze direction of the user who worn the wearable terminal 10.

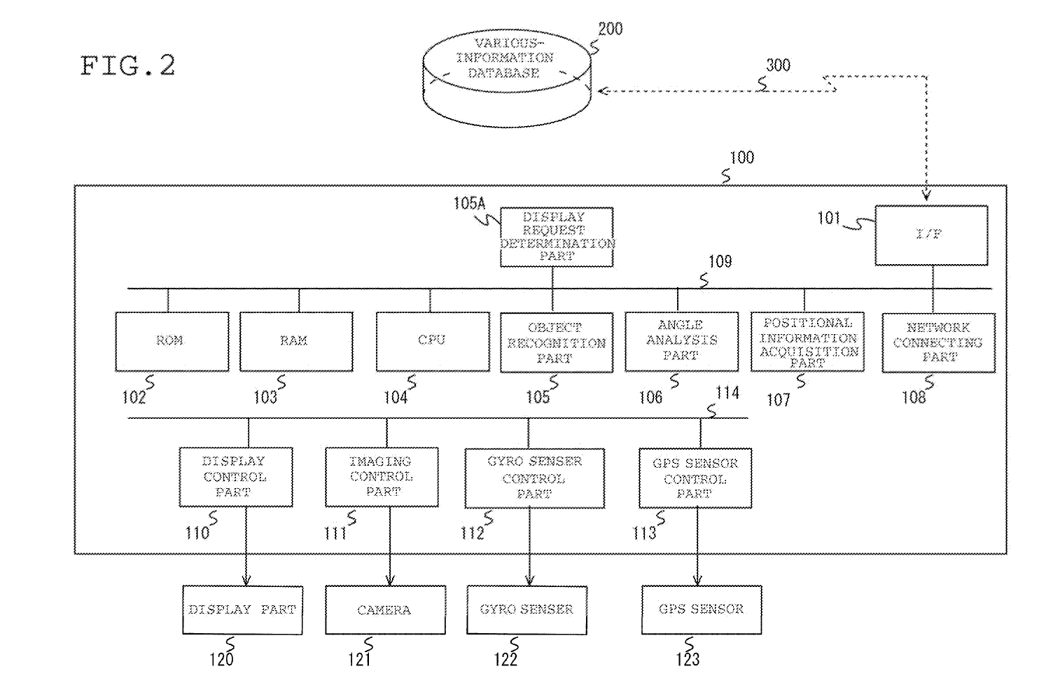

An internal configuration of the equipment main body 100 will next be described with reference to FIG. 2. In this connection, a power source of the equipment main body 100 to be described later may always be turned ON. Alternatively, the equipment main body 100 may take a configuration in which a power source is turned ON by an operation of a touch pad, as in the case of the above-mentioned google glass.

The equipment main body 100 is composed of a part devoted to data analysis or the like and a part devoted to device control. In other words, the part devoted to data analysis includes an I/F (interface) 101, a ROM (Read Only Memory) 102, a RAM (Random Access Memory) 103, a CPU (Central Processing unit) 104, an object recognition part 105, a display request determination part 105A, an angle analysis part 106, a positional information acquisition part 107, and a network connecting part 108. These parts are connected to a data analysis bus 109.

Meanwhile, the part devoted to device control includes a display control part 110, an imaging control part 111, a gyro sensor control part 112, and a GPS sensor control part 113. These parts are connected to a device control bus 114. The data analysis bus 109 and the device control bus 114 are connected to each other via a bus bridge.

The I/F 101 is a circuit such as a network interface card or the like for connecting with a network 300. A wireless may be used as the network 300. The I/F 101 communicates with a various-information database 200 via the network 300. In this connection, the various-information database 200 is a server for storing and managing various kinds of information, such as whether information, electric train timetable, and bus timetable. Then, the various-information database 200 transmits information in response to a display request from the wearable terminal 10 to the wearable terminal 10.

The CPU 104 executes a variety of control programs stored in the ROM 102. The RAM 103 is a work memory for executing the programs. The CPU 104 reads out the programs stored in the ROM 102 to the RAM 103, analyzes, and executes various kinds of processing. In this connection, the ROM 102 stores a display request determination table 105a to be described later.

The object recognition part 105 is a circuit for analyzing an image imaged by the camera 121. Thereby, the object recognition part 105 recognizes an object. The display request determination part 105A is a circuit for determining a display request by a user based on a combination of objects recognized by the object recognition part 105. When determining the display request by the user, the display request determination part 105A refers to a display request determination table 10a to be described later. In other words, if an initial object (first object) is “sky” and a next object (second object) is “hand”, for example, the display request determination part 105A determines that it is a display request wishing to know whether information. On this occasion, the display request determination part 105A refers to the display request determination table 105a to be described later. The details thereof will follow later.

These objects are acquired by gesture of a user who worn the wearable terminal 10. In other words, when a user looks up at the sky, the sky is imaged by the camera 121. Then, when a user holds up a hand toward the sky, the hand held up toward the sky is imaged by the camera 121. Such gesture is a natural act in checking weather, and correlation with a display request wishing to know weather becomes extremely natural. Understandably, when a user holds up a hand toward the sky in a state where the user looks up at the sky, the hand is imaged against the sky. In this instance, the object recognition part 105 recognizes based on an analysis that only the hand is an object.

If an object is only “the sky”, the display request determination part 105A ceases determining a display request by a user. Even when a first object (first object) is “the sky”, it may be quite possible that a next object (second object) is “bird” or “airplane” rather than “hand”. Even in this case, the display request determination part 105A ceases determining a display request by a user. In other words, the display request determining part 105A basically determines a display request by a user based on a combination of the first object and the second object, but ceases determining the display request by the user unless there are objects accord with the combination of the first object and the second object in the display request determination table 105a to be described later. This surely prevents information from being displayed on the display part 120 caused by an incorrect operation when a user does not make a request.

The angle analysis part 106 is a circuit for analyzing an angle in response to a detection signal by the gyro sensor 122. This angle is a tilt angle based on a motion of user's head who worn the wearable terminal 10. An analytical operation by the angle analysis part 106 is used, for example, as a start trigger for image analysis by the object recognition part 105. In this way, the analytical operation by the angler analysis part 106 is taken as a start trigger for image analysis by the object recognition part 105. This eliminates unnecessary processing by the object recognition part 105 or the like in a case where a user does not make a request.

The positional information acquisition part 107 is a circuit for acquiring positional information from data sent from a GPS satellite received by a GPS sensor 123. A network connecting part 108 is a circuit for getting access to the various-information database 200 via the I/F 101 based on a request from the display request determination part 105A. A display request determined by the display request determination part 105A and positional information acquired by the positional information acquisition part 107 are transmitted to the various-information database 200. Then, various kinds of information based on the display request and the positional information are acquired from the various-information database 200.

The display control part 110 is a circuit for control of a display operation of the display part 120. In other words, when the various kinds of information based on the positional information are acquired from the various-information database 200, the display control part 110 causes the display part 120 to display the various kinds of information. In this connection, a display time during which the various kinds of information are displayed on the display part 120 can arbitrarily be set.

The imaging control part 111 is a circuit for control of an imaging operation by the camera 121. The gyro sensor control part 112 is a circuit for control of a detection operation by the gyro sensor 122. The GPS sensor control part 113 is a circuit for control of a receiving operation of data from the GPS satellite received by the GPS sensor 123.

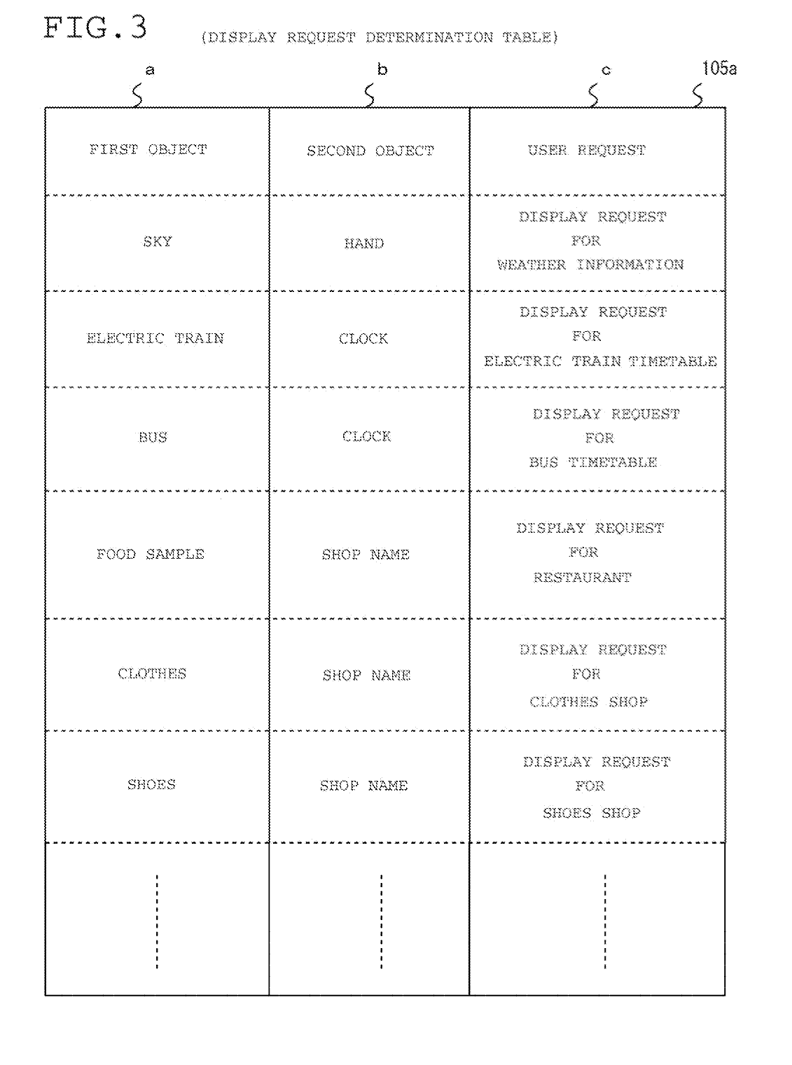

Next, an example of the display request determination table 105a referred by the display request determination part 105A will be described with reference to FIG. 3. In other words, the display request determination table 105a shown in FIG. 3 is referred by the display request determination part 105A in determining a display request by a user based on a recognition result of an image by the object recognition part 105. The display request determination table 105a contains a first object a, a second object b, and a user request c. The user request c is set correspondingly to a combination of the first object a and the second object b.

Namely, when the first object a is “sky” and the second object b is “hand”, the user request c is “display request for weather information”. Further, when the first object a is “electric train” and the second object b is “clock”, the user request c is “display request for electric train timetable”. Furthermore, when the first object a is “bus” and the second object b is “clock”, the user request c is “display request for bus timetable”.

Moreover, when the first object a is “food sample” and the second object b is “store name”, the user request c is “display request for restaurant”. Here, the “food sample” is a food model displayed at a storefront or the like of restaurant. Further, the “store name” is characters written on a signboard installed at a store entrance or the like of restaurant. The “display request for restaurant” of this case can be turned into a display request for stores associated with “the food sample”. In other words, if the “food sample” is ramen, for example, it can be turned into a display request for plural ramen stores. As the “food sample”, it is not necessarily limited to the food model displayed at the storefront of restaurant. For example, the food sample may be a food image run on a book instead.

When the first object a is “clothes” and the second object b is “shop name”, the user request c is “display request for clothes shop”. Here, the “clothes” maybe those worn by a user, or else may be those worn by a familiar person. The “display request for clothes shop” of this case can be turned into a display request for shops associated with the “clothes” of the first object a. In other words, if “the clothes” are a suit, for example, it can be turned into a display request for a plurality of goods store associated with the suit. Further, as “clothes”, it is not necessarily limited to those worn by a person, for example, it may be an image of “clothes” run on a book.

When the first object a is “shoes” and the second object b is “shop name”, the user request c is “display request for shoes shop”. Here, the “shoes” may be those put on by a user, or else it may be those put on by a familiar person. The “display request for shoes shop” of this case can be turned, for example, into a display request for shop associated with the “shoes” of the first object a. In other words, if the“shoes” is sneakers, it can be turned into a display request for a plurality of shoes shop associated with the sneakers. Further, as “shoes”, it is not necessarily limited to those put on by a person, or else it may be an image of “shoes” run on a book.

When access is tried to the various-information database 200 through the network connecting part 108 based on a user request c determined by the display request determination part 105A, positional information acquired by the positional information acquisition part 107 is also transmitted. Therefore, information limited to that around a user can be acquired in either case. When a user wants to acquire wide area information, not limited to the information around a user, it has only, for example, to cease transmitting positional information acquired by the positional information acquisition part 107. In this instance, it should perform processing to cease an operation of the positional information acquisition part 107.

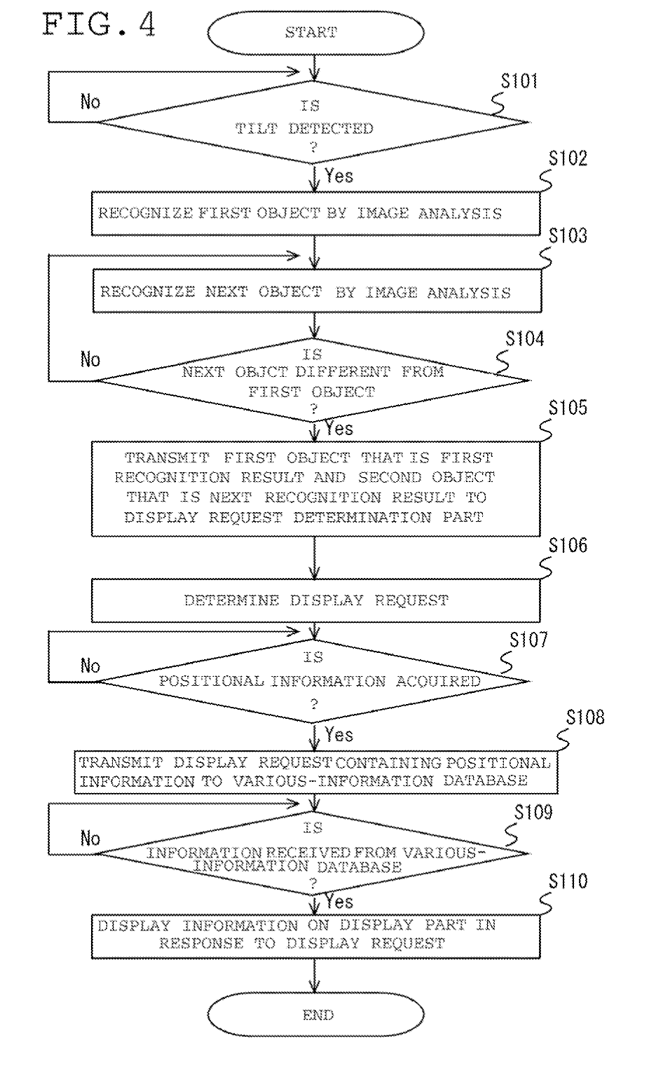

A description will then be made to information display processing by the wearable terminal 10 with reference to FIG. 4. For convenience of explanation, description will be made in the following description, for example, by giving an example where a display request for whether information is made.

### Step S101

First, the angle analysis part 106 determines whether a tilt is detected by the gyro sensor 122. If it is determined by the angle analysis part 106 that a tilt is not detected by the gyro sensor 122 (step S101: No), the angle analysis part 106 waits until the gyro sensor 122 detects a tilt. Otherwise, if it is determined by the angle analysis part 106 that a tilt is detected by the gyro sensor 122 (step S101: Yes), a process proceeds to step S102. In other words, when a user who wears the wearable terminal 10 looks up at the sky, a signal from the gyro sensor 122 is changed. Accordingly, the angle analysis part 106 can determine that a tilt is detected by the gyro sensor 122.

### Step S102

If it is determined by the object recognition part 105 that a tilt is detected by the angle analysis part 106, the object recognition part 105 analyzes an image imaged by the camera 121. Thereby, the object recognition part 105 recognizes the object. At this time, for example, the sky is imaged by the camera 121 by gesture that a user looks up at the sky. Then, the object recognition part 105 analyzes the image imaged by the camera 121, and recognizes that the object is the sky. As mentioned above, the camera 121 is a video camera whose imaging period per one image is, for example, 1/30 seconds, and which is capable of imaging the object. In other words, a frame rate of the video camera is 30 fps. Thereby, the camera 121 successively images an object in a gaze direction of a user who worn the wearable terminal 10. For this reason, the object recognition part 105 can successively recognize the object.

### Step S103

When a first recognition of the object is completed, the object recognition part 105 analyzes an image imaged by the camera 121, and starts to recognize a next object.

### Step S104

The object recognition part 105 determines whether or not the recognized next object is different from the first object. If it is determined that the recognized next object is not different from the first object (step S104: No), a process returns back to step S103. This is because the next object is identical with the first object. Otherwise, if it is determined that the next object is different from the first object (step S104: Yes), a process proceeds to step S105. In other words, lets us suppose here, for example, a case where an image imaged in a state where a user looks up at the sky is recognized as a next object. In this case, because the next object is identical with the first object, a process returns back to step S103 and starts to recognize again a next object. Instead, lets us suppose here a case where a user makes gesture of holding up user's hand toward the sky while a user looks up at the sky. In this case, the hand against the sky is imaged by the camera 121. Then, the object recognition part 105 recognizes the hand as a next object from which the background is removed by virtue of image analysis.

### Step S105

The object recognition part 105 transmits a first object (sky) that is a first recognition result and a second object (hand) that is a next recognition result to the display request determination part 105A.

### Step S106

When the display request determination part 105A receives the recognition result from the object recognition part 105, the display request determination part 105A refers to the display request determination table 105a. Thereby, the display request determination part 105A determines a display request from a user. In this case, the display request determination part 105A determines that a user request c is a display request for whether information from a combination of the first object (sky) and the second object (hand).

### Step S107

The display request determination part 105A determines whether or not positional information is acquired by the GPS sensor 123. If it is determined by the display request determination part 105A that the positional information is not acquired by the GPS sensor 123 (step S107: No), the display request determination part 105A waits until the positional information is acquired detected by the GPS sensor 123. Otherwise, if it is determined by the display request determination part 105A that the positional information is acquired by the GPS sensor 123 (step S107: Yes), a process proceeds to step S108.

### Step S108

The display request determination part 105A transmits a display request (display request for whether information) containing the positional information to the various-information database 200 via the network connecting part 108.

### Step S109

The display request determination part 105A determines whether or not information is received from the various-information database 200 via the network connecting part 108. If it is determined by the display request determination part 105A that the information is not received from the various-information database 200, the display request determination part 105A waits until the information is received from the various-information database 200 (step S109: No). Otherwise, if it is determined by the display request determination part 105A that the information is received from the various-information database 200 (step S109: Yes), a process proceeds to step S110.

### Step S110

If the information is received form the various-information database 200, the display request determination part 105A causes the display part 120 to display weather information through the display control part 110. This weather information is based on the positional information acquired by the positional information acquisition part 107. In other words, the weather information is information around a user.

### Step S111

In the above, a description was made about a display request for the weather information. However, a display request for electric train timetable, a display request for bus timetable, a display request for restaurant, a display request for clothes shop, a display request for shores shop, or the like shown in the above-mentioned user request c of the display request determination table 105a are also determined based on a combination of the first object and the second object. This is based on recognition results of each image imaged by the above-mentioned gesture of a user.

Thus, in the present embodiment, the object recognition determination part 105A recognizes an object from an image imaged by the camera 121 that is an imaging part. The object recognition determination part 105A determines a display request based on a combination of different objects recognized by the object recognition part 105. The display request determination part 105A makes a transmission request for information in response to a display request to the various-information database (various-information database 200) via the I/F 101 and the network connecting part 108 that are a communication part. The I/F 101 and the network connecting part 108 that are a communication part acquire various kinds of information from the various-information database (various-information database 200) in which various kinds of information are stored. Then, the display part 120 displays the various kinds of information.

Thereby, the display request is determined based on a combination of the different objects in response to gesture of a user. Accordingly, it allows identification of a variety of display requests by a user. As a result, it enables the provision of information in response to the variety of display requests by the user.

In the present embodiment, the angle analysis part 106 analyzes a tilt angle based on a motion based on gesture of a user. Then, the object recognition part 105 recognizes an object with an analytical operation by the angle analysis part 106. Thereby, the analytical operation by the angle analysis part 106 can be taken as a start trigger for image analysis by the object recognition part 105. Accordingly, it allows elimination of unnecessary processing by the object recognition part 105 or the like in a case where a user makes no display request.

Further, in the present embodiment, when the display request recognition part 105A makes a transmission request for information in response to a display request, the transmission request contains the positional information acquired by the positional information acquisition part 107. Therefore, information acquired from the various-information database 200 can be limited to that around a user.

Furthermore, in the present embodiment, the display request determination part 105a determines a display request referring to the display request determination table 105a. The display request determination table 105a shows a plurality of display requests in response to a combination of the different objects. For this reason, if there is no display requests matched with a combination of the different objects (first object and second object) in the display request determination table 105a, no determination of display request by a user is made. This prevents information from being displayed on the display part 120 caused by an incorrect operation when a user makes no request.

Summarizing the above, in the display control method by gesture in the above-mentioned typical case, it is designed to enable selection and display of necessary information by a motion of hand or by a motion of object held by hand. Thus, it is considered to allow a secure and easy operation to be achieved even by a person unfamiliar with an operation.

In such a display control method by gesture, however, it is designed to move a cursor based on a motion of hand or with a movement of object held by hand. This is because an icon displayed on a large display or the like is selected. In other words, the motion of hand or the movement of object held by hand will be confined to transmit a request for selecting an icon displayed beforehand on the large display by moving a cursor or the like.

For this reason, when attempting to apply the display control method of this kind by gesture to the operation settings in the above-mentioned wearable terminal, it becomes less able to identify various requests of a user. For such a reason, the display control method was not able to provide information in response to various requests of a user.

According to the electronic equipment and the information display program of the present disclosure, a display request is determined based on a combination of the different objects based on gesture of a user. This enables identification of various display requests of a user. Accordingly, the present disclosure allows the provision of information in response to various display requests of a user.

In the present embodiment, while a description was made, for example, by giving the eyeglass-type wearable terminal as an example of the electronic equipment of the present disclosure, not necessarily limited thereto, the present disclosure is applicable to the other wearable terminals, such as a watch-type wearable terminal and a bracelet-type wearable terminal.

What is claimed is:

1. An electronic equipment comprising:
a communication circuit that acquires various kinds of information from a various-information database in which the various kinds of information are stored via a network;
a display circuit that displays the various kinds of information; an imaging circuit that images a real space;
an object recognition circuit that recognizes an object from an image imaged by the imaging circuit; and
a display request determination circuit that determines a display request based on a combination of different objects recognized by the object recognition circuit, and makes a transmission request for information to the various kinds of information database in response to the display request through the communication circuit.

2. The electronic equipment according to claim 1, further comprising an angle analysis circuit that analyzes a tilt angle based on a motion corresponding to gesture of a user, and wherein the object recognition circuit recognizes the object based on an analytical operation by the angle analysis circuit.

3. The electronic equipment according to claim 1, further comprising a positional information acquisition circuit that acquires positional information, and wherein the display request determination circuit contains the positional information in the display request when making a transmission request for information in response to the display request.

4. The electronic equipment according to claim 1, further comprising a display request determination table that indicates a plurality of display requests based on a combination of the different objects, and wherein the display request determination circuit determines the display request referring to the display request determination table.

5. An information display method executed on a computer for control of an electronic equipment comprising the steps of:
acquiring various kinds of information from a various-information database in which various kinds of information are stored via a network through a communication circuit;
displaying the various kinds of information by a display circuit; imaging a real space by an imaging circuit;
recognizing an object by an object recognition circuit from an image imaged by the imaging circuit; and
determining a display request by a display request determination circuit based on a combination of different objects recognized by the object recognition circuit and making a transmission request for information to the various-information database in response to the display request through the communication circuit.

6. A non-transitory computer readable storing medium storing an information display program executable on a computer of an electronic equipment, the information display program causing the computer to function as:
a communication circuit that acquires various kinds of information from a various-information database in which various kinds of information are stored via a network;
a display circuit that display the various kinds of information; an imaging circuit that images a real space;
an object recognition circuit that recognizes an object from an image imaged by the imaging circuit; and
a display request determination circuit that determines a display request based on a combination of different objects recognized by the object recognition circuit, and makes a transmission request for information to the various-information database in response to the display request through the communication circuit.
